(19) United States
(12) Patent Application Publication
(10) Pub. No.: US 2013/0295980 A1
(43) Pub. Date: Nov. 7, 2013

(54) DETERMINING NOISE LEVELS IN FREQUENCY BAND(S) IN DISTRIBUTED ANTENNA SYSTEMS AND ADJUSTING FREQUENCY BAND(S) OF COMMUNICATIONS SIGNALS IN RESPONSE, AND RELATED COMPONENTS, SYSTEMS, AND METHODS

(71) Applicant: CORNING MOBILEACCESS LTD., Airport City (IL)

(72) Inventors: Rami Reuven, Rishon Letzion (IL); Ofer Saban, Vienna, VA (US); Isaac Shapira, Petach Tikva (IL)

(73) Assignee: Corning MobileAccess Ltd., Airport City (IL)

(21) Appl. No.: 13/873,927

(22) Filed: Apr. 30, 2013

Related U.S. Application Data
(60) Provisional application No. 61/642,835, filed on May 4, 2012.

(51) Int. Cl. H04B 17/00

(52) U.S. Cl. CPC H04B 17/0055
USPC 455/514; 455/226.3

(57) ABSTRACT

Determining noise levels in frequency band(s) for communications paths in distributed antenna systems. Noise may be induced in communications paths in distributed antenna system as a result of electromagnetic interference from communications media located in close proximity and/or from other electronic devices. Noise induced on communications media may not be evenly distributed across the frequency spectrum, but instead concentrated in certain portions of the frequency spectrum. The frequency band(s) of communication signals distributed in the distributed antenna systems may be adjusted to be provided outside of frequency band(s) having unacceptable noise levels. In this manner, the communications performance (e.g., the signal-to-noise (S/N) ratio) of communications signals communicated in the distributed antenna systems may be improved.

### PRIORITY APPLICATIONS

This application claims the benefit of priority under 35 U.S.C. §119 of U.S. Provisional Patent Application No. 61/642,835, filed on May 4, 2012 and entitled “Determining Noise Levels in Frequency Band(s) in Distributed Antenna Systems and Adjusting Frequency Band(s) of Communications Signals in Response, and Related Components, Systems, and Methods,” the content of which is relied upon and incorporated herein by reference in its entirety.

### BACKGROUND

1. Field of the Disclosure

The technology of the disclosure relates to distributed antenna systems configured to provide communications signals over a communications medium to and from one or more remote access units for communicating with client devices.

2. Technical Background

Wireless communication is rapidly growing, with ever-increasing demands for high-speed mobile data communication. As an example, local area wireless services (e.g., so-called “wireless fidelity” or “WiFi” systems) and wide area wireless services are being deployed in many different types of areas (e.g., coffee shops, airports, libraries, etc.). Distributed communications or antenna systems communicate with wireless devices called “clients,” “client devices,” or “wireless client devices,” which must reside within the wireless range or “cell coverage area” in order to communicate with an access point device. Distributed antenna systems are particularly useful to be deployed inside buildings or other indoor environments where client devices may not otherwise be able to effectively receive radio-frequency (RF) signals from a source, such as a base station for example. Example applications where distributed antenna systems can be used to provide or enhance coverage for wireless services include public safety, cellular telephony, wireless local access networks (LANs), location tracking, building automation, and medical telemetry inside buildings and over campuses.

One approach to deploying a distributed antenna system involves the use of radio frequency (RF) antenna coverage areas, also referred to as “antenna coverage areas.” Antenna coverage areas can be formed by remotely distributed antenna units, also referred to as remote units. The remote units each contain or are configured to couple to one or more antennas configured to support the desired frequency(ies) or polarization to provide the antenna coverage areas. Antenna coverage areas can have a radius in the range from a few meters up to twenty meters as an example. Combining a number of remote units creates an array of antenna coverage areas. Because the antenna coverage areas each cover small areas, there typically may be only a few users (clients) per antenna coverage area.

Distributed antenna systems can be configured to serve a single communications service or a combination of many communications services operating over multiple radio bands. Different communications mediums can be employed for distributing communications signals to the remote units, including but not limited to electrical conductors (e.g., twisted pair wires, coaxial cables), optical fibers, and wireless transmissions. Distributed antenna systems can be employed in existing distributed antenna systems where wireless signals are distributed over the same cabling as provided between a hub and access points (APs) in the distributed antenna systems. For example, multiple communications wires can be provided to carry multiple communications signals for different clients and different remote units in a distributed antenna system. These cablings may be located in close proximity each other, such as when included in the same main cabling jacket or conduit. Electromagnetic noise emitted from the communications wires located in close proximity, as well as from radio transmitters, and other environmental electronic devices, such as motors, transformers, etc., can be induced into the communications wires and interfere with the carried communications signals. The induced noise can particularly cause communications performance issues if a distributed antenna system is operating at or near bandwidth capacity of the communications wires.

### SUMMARY OF THE DETAILED DESCRIPTION

Embodiments disclosed herein include determining noise levels in frequency band(s) for communications paths in distributed antenna systems. Noise may be induced in communications paths in distributed antenna systems as a result of electromagnetic interference from communications media located in close proximity and/or from other electronic devices. Noise induced on communications media may not be evenly distributed across the frequency spectrum, but instead concentrated in certain portions of the frequency spectrum. In this regard, the frequency band(s) of communication signals distributed in the distributed antenna systems made by adjusted to be provided outside of frequency band(s) having unacceptable noise levels. In this manner, the communications performance (e.g., the signal-to-noise (S/N) ratio) of communications signals communicated in the distributed antenna systems may be improved. Related components, systems, and methods are also disclosed.

In this regard, in one embodiment, a noise detection circuit for detecting noise in a distributed antenna system is provided. The noise detection circuit comprises a scanning circuit. The scanning circuit is configured to receive an input distributed antenna system communications signal. The scanning circuit is also configured to scan the input distributed antenna system communications signal at a plurality of scan frequencies in a frequency spectrum of a distributed antenna system. The scanning circuit is also configured to generate a plurality of output scan communications signals each centered at a scan frequency among the plurality of scan frequencies. The noise detection circuit also comprises a power detector. The power detector is configured to detect the energy level of the plurality of output scan communications signals and provide a plurality of output signals indicative of noise levels in the distributed antenna system for each of the plurality of scan frequencies.

In another embodiment, a method of detecting noise in a distributed antenna system is provided. The method includes receiving an input distributed antenna system communications signal. The method also includes scanning the input distributed antenna system communications signal at a plurality of scan frequencies in a frequency spectrum of a distributed antenna system. The method also includes generating a plurality of output scan communications signals each centered at a scan frequency among the plurality of scan frequencies. The method also includes detecting the energy level of the plurality of output scan communications signals. The method also includes generating a plurality of output signals indicative of noise levels in the distributed antenna system for each of the plurality of scan frequencies.

In another embodiment, a central unit providing communications signals in a distributed antenna system is provided. The central unit comprises at least one communications interface. The communications interface is configured to receive communications signals at a communications frequency for at least one communications service. The communications interface is also configured to communicate the communications signals over at least one communications medium at a tuned frequency between a plurality of remote units. The central unit also comprises a controller. The controller is configured to select a communications medium among the at least one communications medium for a remote unit among the plurality of remote units. The controller is also configured to instruct a noise detection circuit to scan the selected communications medium at a plurality of scan frequencies in a frequency spectrum. The controller is also configured to receive a power level on the selected communications medium at each of the plurality of scan frequencies. The controller is also configured to store the scan frequency and power level on the selected communications medium for each of the plurality of scan frequencies.

In another embodiment, a method of detecting noise levels on communications media of a distributed antenna system is provided. The method includes receiving communications signals at a communications frequency for at least one communications service. The method also includes communicating the communications signals over at least one communications medium at a tuned frequency between a plurality of remote units. The method also includes selecting a communications medium among the at least one communications medium for a remote unit among the plurality of remote units. The method also includes instructing a noise detection circuit to scan the selected communications medium at a plurality of scan frequencies in a frequency spectrum. The method also includes receiving a power level on the selected communications medium at each of the plurality of scan frequencies. The method also includes storing the scan frequency and power level on the selected communications medium for each of the plurality of scan frequencies.

In another embodiment, a distributed antenna system is provided. The distributed antenna system includes a plurality of remote units. A plurality of noise detection circuits for detecting noise are disposed in each of the plurality of remote units. Each of the plurality of noise detection circuits includes a scanning circuit. The scanning circuit is configured to receive an input distributed antenna system communications signal. The scanning circuit is also configured to scan the input distributed antenna system communications signal at a plurality of scan frequencies in a frequency spectrum of a distributed antenna system. The scanning circuit is also configured to provide a plurality of output scan communications signals each centered at a scan frequency among the plurality of scan frequencies. The scanning circuit also includes a power detector that is configured to detect the energy level of the plurality of output scan communications signals and provide a plurality of output signals indicative of noise levels in the distributed antenna system for each of the plurality of scan frequencies. The distributed antenna system also comprises a central unit. The central unit includes at least one communications interface. The at least one communications interface is configured to receive communications signals at a communications frequency for at least one communications service. The at least one communications interface is also configured to communicate the communications signals over at least one communications medium at a tuned frequency between the plurality of remote units. The distributed antenna system also comprises a controller. The controller is configured to select a communications medium among the at least one communications medium for a remote unit among the plurality of remote units. The controller is also configured to instruct the plurality of noise detection circuits to each scan the selected communications medium at a plurality of scan frequencies in a frequency spectrum. The controller is also configured to receive a power level on the selected communications medium at each of the plurality of scan frequencies from each of the plurality of noise detection circuits. The controller is also configured to store the scan frequency and power level on the selected communications medium for each of the plurality of scan frequencies for each of the plurality of noise detection circuits.

The central units and remote units disclosed herein can be configured to support both radio-frequency (RF) communication services and digital data services. These communications services can be wired or wireless communications services that are typically communicated wirelessly, but may be provided over non-wireless medium (e.g., electrical conductor and/or optical fiber). The RF communication services and digital data services can be provided over any type of communications medium, including electrical conductors and optical fiber to wireless client devices, such as remote units for example. Non-limiting examples of digital data services include LAN using Ethernet, WLAN, WiMax, WiFi, Digital Subscriber Line (DSL), telephony, WCDMA, and LTE, which can support voice and data. Digital data signals can be provided over separate communications media for providing RF communication services. Alternatively, digital data signals can be provided over a common communications medium with RF communications signals.

Additional features and advantages will be set forth in the detailed description which follows, and in part will be readily apparent to those skilled in the art from that description or recognized by practicing the embodiments as described herein, including the detailed description that follows, the claims, as well as the appended drawings.

It is to be understood that both the foregoing general description and the following detailed description present embodiments, and are intended to provide an overview or framework for understanding the nature and character of the disclosure. The accompanying drawings are included to provide a further understanding, and are incorporated into and constitute a part of this specification. The drawings illustrate various embodiments, and together with the description serve to explain the principles and operation of the concepts disclosed.

### BRIEF DESCRIPTION OF THE FIGURES

FIG. 1 is a schematic diagram of an exemplary distributed antenna system providing distributed communications services between a central unit and remote units, and noise induced on communications media carrying communications signals between the central unit and remote units;

FIG. 2 is a schematic diagram of an exemplary noise detection circuit that can be deployed in a component(s) distributed antenna system in FIG. 1, wherein the noise detection circuit is configured to measure noise levels induced on communication media in the frequency spectrum of the distributed antenna system;

FIG. 3 is a flowchart illustrating an exemplary process of controlling the noise detection circuit in FIG. 2 to measure and record noise levels induced on communication media in a distributed antenna system;

FIG. 4 is an exemplary spectrum map of noise levels detected by the noise detection circuit employing the process in FIG. 3 over the frequency spectrum of a distributed antenna system;

FIG. 5 is a flowchart illustrating an exemplary process of evaluating the noise levels detected by the noise detection circuit in FIG. 3 and/or the spectrum map determined in FIG. 4 in a distributed antenna system to adjust the frequency band(s) of the communication signals outside of the frequency(ies) of detected noise to improve communications performance;

FIG. 6 is a schematic diagram of another exemplary noise detection circuit that can be deployed in a component(s) distributed antenna system in FIG. 1, wherein the noise detection circuit is configured to measure noise levels induced on an alternative arrangement communication media configured in a phantom circuit arrangement;

FIG. 7 is a schematic diagram of another exemplary distributed antenna system in which the noise detection and frequency band(s) adjustment, including in accordance to FIGS. 3-5, may be provided, wherein the distributed antenna system includes distribution of radio-frequency (RF) communications services and digital data communications services, wherein the distributed WLAN and RF communications systems share a distribution communications media; and

FIG. 8 is a schematic diagram of a generalized representation of an exemplary controller provided in the form of a computer system that can be included in the central unit to control noise detection circuits and detect noise and adjust communications signals frequency bands in response, including in accordance with FIGS. 3-5, wherein the exemplary computer system is adapted to execute instructions from an exemplary computer-readable media.

### DETAILED DESCRIPTION

Reference will now be made in detail to the embodiments, examples of which are illustrated in the accompanying drawings, in which some, but not all embodiments are shown. Indeed, the concepts may be embodied in many different forms and should not be construed as limiting herein; rather, these embodiments are provided so that this disclosure will satisfy applicable legal requirements. Whenever possible, like reference numbers will be used to refer to like components or parts.

Embodiments disclosed herein include determining noise levels in frequency band(s) for communications paths in distributed antenna systems. Noise may be induced in communications paths in distributed antenna system as a result of electromagnetic interference from communications media (e.g., communications wires) located in close proximity and/or from other electronic devices. Noise induced on communications wires may not be evenly distributed across the frequency spectrum, but instead concentrated in certain portions of the frequency spectrum. In this regard, the frequency band(s) of communication signals distributed in the distributed antenna systems made by adjusted to be provided outside of frequency band(s) having unacceptable noise levels. In this manner, the communications performance (e.g., the signal-to-noise (S/N) ratio) of communications signals communicated in the distributed antenna systems may be improved. Related components, systems, and methods are also disclosed.

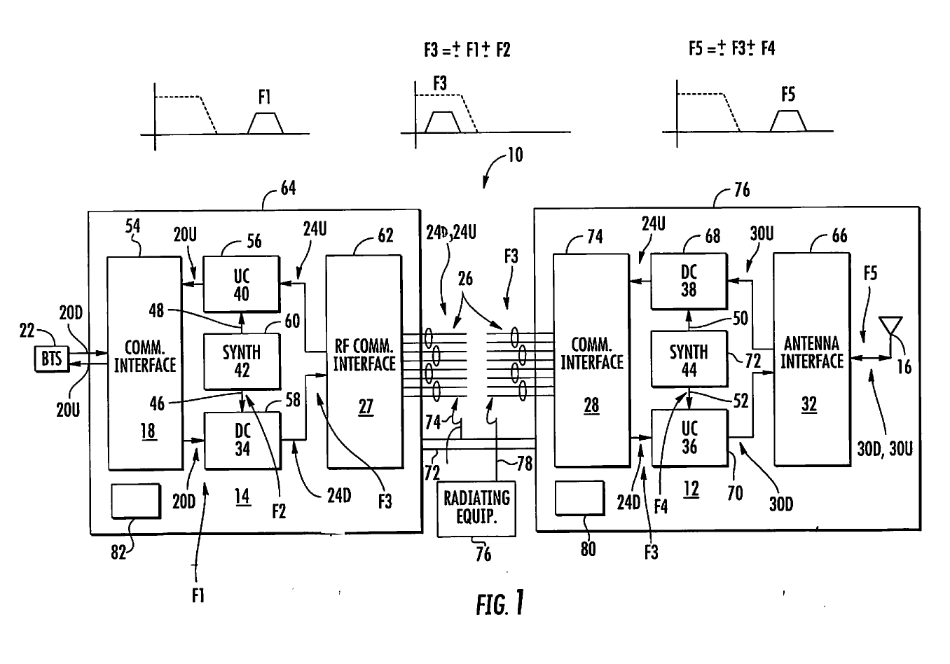

In this regard, FIG. 1 is a schematic diagram of an exemplary distributed antenna system 10. Before discussing induction of noise in the distributed antenna system 10 and the circuits, systems, and methods for detecting noise levels and adjusting the frequency band(s) of communications signals in response, the components and functionality of the distributed antenna system 10 are provided.

With reference to FIG. 1, the distributed antenna system 10 in this embodiment is configured to distribute communications signals to remote locations, as will be described in more detail below. The distributed antenna system 10 is configured to create one or more antenna coverage areas for establishing communications with wireless client devices located in the RF range of the antenna coverage areas created by remote units 12. The remote units 12 may also be termed remote antenna units if they contain one or more antennas to support wireless communications. The distributed antenna system 10 provides any type of communication services desired, for example cellular radio services and/or digital data services, as non-limiting examples. In this embodiment, the distributed antenna system 10 includes a central unit 14, one or more remote units 12, and a communications media 26 that communicatively couples the central unit 14 to the remote unit 12. The central unit 14 is configured to provide communication services to the remote unit 12 for wireless propagation to client devices in communication range of an antenna 16 of the remote unit 12. The remote unit 12 may also be configured to support wired communications services. Note that although only one remote unit 12 is illustrated as being communicatively coupled to the central unit 14 in FIG. 1, a plurality of remote units 12 can be communicatively coupled to the central unit 14 to receive communication services from the central unit 14.

With continuing reference to FIG. 1, the central unit 14 includes a communications interface in the form of a communications interface 18 that is configured to receive downlink communication signals 20D for communication services to be provided to the remote unit 12. The downlink communications signals 20D may be at a carrier or center frequency F₁, as illustrated in FIG. 1. The communications interface 18 may receive the downlink communications signals 20D to be provided to the remote unit 12 from a base transceiver station (BTS) 22 as a non-limiting example. As will be discussed in more detail below, the central unit 14 is configured to provide downlink communication signals 24D through a communications interface 27 to provide the communication services based on the downlink communications signals 20D over a communications media 26 to the remote unit 12.

With continuing reference to FIG. 1, the communications interface 27 could include a cable interface that interfaces with a cable media (e.g., wire conductors (e.g., twisted pair), coaxial cable, fiber optic cable) for sending and receiving communications signals. The remote unit 12 includes a communications interface 28 configured to receive the downlink communication signals 24D and provide downlink communication signals 30D providing the communications services to an antenna interface 32. The antenna 16 electrically coupled to the antenna interface 32 is configured to wirelessly radiate the downlink communication signals 30D to wireless clients in wireless communication range of the antenna 16. The communications interface 28 could include a cable interface that interfaces with a cable media (e.g., wire conductors (e.g., twisted pair), coaxial cable, fiber optic cable) for sending and receiving communications signals, including the downlink communication signals 30D.

The downlink communication signals 24D, 30D may be the same signals thus being at the same carrier frequency as the downlink communication signals 20D. Alternatively, as provided in the distributed antenna system 10 of FIG. 1, the downlink communications signals 20D are frequency shifted by down converter circuit (DC) 34 to provide downlink communications signals 24D. The downlink communications signals 20D are converted to the downlink communications signals 24D to an intermediate frequency (IF) F₃ different from (e.g., lower or higher than) the frequency of downlink communications signals 20D. To recover the downlink communication signals 20D at the remote unit 12 to be radiated by the antenna 16, an up converter circuit (UC) 36 is provided in the remote unit 12 to up convert the downlink communications signals 24D to the downlink communications signals 30D. The downlink communication signals 30D are of the same or substantially the same frequency as the downlink communications signals 20D in this embodiment. The downlink communication signals 30D may be frequency locked to the downlink communications signals 20D, such as through employing a frequency correction circuit in the UC 36, as a non-limiting example. The downlink communication signals 30D may be phase locked to the downlink communications signals 20D, such as through employing a phase locked loop (PLL) circuit in the UC 36 as another non-limiting example.

With continuing reference to FIG. 1, the communications interface 18 in this embodiment is also configured to receive uplink communication signals 20U to provide uplink communications received at the remote unit 12 from wireless client devices to the central unit 14. In this regard, the communications interface 18 receives the uplink communications signals 24U from the remote unit 12 via the communications interfaces 28, 27 in the remote unit 12 and central unit 14, respectively. The remote unit 12 is configured to provide the uplink communication signals 24U through the communications interface 28 to provide uplink communications for the communication services over the communications media 26 to the communications interface 27 of the central unit 14. The uplink communication signals 24U are based on the uplink communication signals 30U received by the antenna 16 of the remote unit 12 from wireless client devices. The uplink communication signals 24U may be the same signals as the uplink communication signals 30U.

Alternatively, with continuing reference to FIG. 1, the uplink communications signals 30U are frequency shifted by down converter circuit (DC) 38 in the remote unit 12 to provide uplink communications signals 24U. The uplink communications signals 30U are down converted to the uplink communications signals 24U to an intermediate frequency (IF) that is different from the frequency of downlink communications signals 30U. To recover the uplink communication signals 30U at the central unit 14 to be provided to the BTS 22, an up converter circuit (UC) 40 is provided in the central unit 14 to up convert the uplink communications signals 24U to the uplink communications signals 20U. The uplink communication signals 20U are of the same or substantially the same frequency as the uplink communications signals 30U in this embodiment. The uplink communication signals 20U may be frequency locked to the uplink communications signals 30U, such as through employing a frequency locked loop (FLL) circuit in the UC 40, as a non-limiting example. The uplink communication signals 20U may be phase locked to the uplink communications signals 30U, such as through employing a phase locked loop (PLL) circuit in the UC 40 as another non-limiting example.

With continuing reference to FIG. 1, the communications media 26 in the distributed antenna system 10 could be any number of media. For example, the communications medium may be electrical conductors, such as twisted-pair wiring or coaxial cable, as non-limiting examples. Frequency division multiplexing (FDM) or time division multiplexing (TDM) can be employed to provide communications signals between the central unit 14 and multiple remote units 12 communicatively coupled to the central unit 14 over the same communication media 26. Alternatively, separate, dedicated communications media 26 may be provided between each remote unit 12 and the central unit 14. The UCs 36, 40, and DCs 38, 34 in the remote units 12 and the central unit 14, respectively, could be provided to frequency shift at different IFs to allow communications signals from multiple remote units 12 to be provided over the same communications media 26 without interference in RF communications signals (e.g., if different codes or channels not employed to separate signals for different users).

Also, for example, the communications media 26 may have a lower frequency handling rating than the frequency of the RF communication service. In this regard, the down conversion of the downlink and uplink RF communication signals 20D, 30U can frequency shift the signals to an IF that is within the frequency rating of the communications media 26. The communications media 26 may have a lower bandwidth rating than the bandwidth requirements of the RF communications services. Thus, again, the down conversion of the downlink and uplink RF communication signals 20D, 30U can frequency shift the signals to an IF that provides a bandwidth range within the bandwidth range of the communications media 26. For example, the distributed antenna system 10 may be configured to be employed using an existing communications media 26 for other communications services, such as digital data services (e.g., WLAN services). For example, the communications media 26 may be Category 5, 6, or 7 (i.e., CAT 5, CAT 6, CAT 7) conductor cable that is used for wired services such as Ethernet based LAN as a non-limiting example. In this example, down conversion ensures that the downlink and uplink RF communications signals 24D, 24U can be properly communicated over the communications media 26 with acceptable signal attenuation.

With continuing reference to FIG. 1, to provide reference signals for frequency conversion by the DCs 34, 38 and the UCs 40, 36 in the central unit 14 and the remote unit 12, respectively, synthesizer circuits 42, 44 are provided. The synthesizer circuit 42 is provided in the central unit 14. The synthesizer circuit 44 is provided in the remote unit 12. The synthesizer circuit 42 in the central unit 14 provides one or more local oscillator (LO) signals 46 at frequency F₂ to the DC 34 for frequency shifting the downlink communications signals 20D to the downlink communications signals 24D at a different, intermediate frequency (IF). The synthesizer circuit 42 also provides one or more reference signals 48 to the UC 40 for frequency shifting the uplink communications signals 24U from the IF to the frequency of the communication services to provide the uplink RF communications signals 20U.

As a non-limiting example, the LO signals 46, 48 may be directly provided to mixers in the DC 34 and UC 40 to control generation of mixing RF signals (not shown) to be mixed with the downlink communications signals 20D and the uplink communications signals 24U, respectively, for frequency shifting. As another non-limiting example, the LO signals 46, 48 may not be provided directly to mixers in the DC 34 and UC 40. The LO signals 46, 48 may be provided to control other circuits that provide signals to control the mixers in the DC 34 and the UC 40. The oscillators in the DC 34 and the UC 40 generate mixing RF signals to be mixed with the downlink communications signals 20D and the uplink communications signals 24U, respectively, for frequency shifting.

The synthesizer circuit 44 in the remote unit 12 provides one or more LO signals 50 to the DC 38 for frequency shifting the uplink communications signals 30U to the uplink communications signals 24U at a different, intermediate frequency (IF). The synthesizer circuit 44 also provides one or more LO signals 52 at frequency F₄ to the UC 36 for frequency shifting the downlink communications signals 24D from the IF to the original frequency F₅ of the communications services to provide the uplink communication signals 30D. As a non-limiting example, the LO signals 50, 52 may be directly provided to mixers in the DC 38 and UC 36 to control generation of mixing signals (not shown) to be mixed with the downlink communications signals 24D and the uplink communications signals 30U, respectively, for frequency shifting. As another non-limiting example, the LO signals 50, 52 may not be provided directly to mixers in the DC 38 and UC 36. The LO signals 50, 52 may be provided to control other circuits that provide signals to control the mixers in the DC 38 and the UC 36. The oscillators in the synthesizer circuit 44 and the UC 36 generate mixing RF signals to be mixed with the downlink communications signals 24D and the uplink communications signals 30U, respectively, for frequency shifting.

The distributed antenna system 10 in FIG. 1 can include one or more RF integrated circuit (RFIC) chips for providing the distributed antenna system functionalities, including those functionalities discussed above. A RFIC chip is a specially designed integrated circuit that includes desired groupings of circuits or components described herein for realizing specific functionality for specific needs. By providing RFIC chips, part count and/or board area (or density) for circuits or components described herein may be reduced. As a non-limiting example, a RFIC chip may enable all electronic circuits for the central unit 14 or a remote unit 12 to be provided with less than seventy percent (70%), fifteen integrated circuits, and/or four hundred (400) passive components as compared to designs that do not employ RFIC chips. As another example, RFIC chips can enable electronic circuits to be provided in a square area of less than 100 cm².

Providing distributed antenna system 10 functionalities in RFIC chips can allow integration of multiple electronic circuits that provide multiple functionalities in a single RFIC chip or reduced RFIC chip set. Cost reductions, size reduction, increased performance, increased reliability, and improved manufacturability in electronic circuits in the distributed antenna system 10 and components are non-limiting examples of advantages that may be realized by providing RFICs in the distributed antenna system 10 components.

With continuing reference to the distributed antenna system 10 in FIG. 1, the communications interface 18 in the central unit 14 contains a radio interface circuit that can be included in a radio interface RFIC chip 54. The UC 40 in the central unit 14 contains an up conversion circuit that can be included in an up conversion RFIC chip 56. The DC 34 in the central unit 14 contains a down conversion circuit that can be included in a down conversion RFIC chip 58. The synthesizer circuit 42 in the central unit 14 can be included in a synthesizer RFIC chip 60. The communications interface 27 in the central unit 14 contains a communications interface circuit that can be included in a communications interface RFIC chip 62. Alternatively, the communications interface 18, the UC 40, the DC 40, the synthesizer circuit 42, and the communications interface 27, or any combination or subset of the foregoing, could be included in a single central unit RFIC chip 64.

With continuing reference to the distributed antenna system 10 in FIG. 1, the antenna interface 32 in the remote unit 12 contains an antenna interface circuit that can be included in an antenna interface RFIC chip 66. The DC 38 in the remote unit 12 contains a down conversion circuit that can be included in a down conversion RFIC chip 68. The UC 36 in the remote unit 12 contains an up conversion circuit that can be included in an up conversion RFIC chip 70. The synthesizer circuit 44 in the remote unit 12 can be included in a synthesizer RFIC chip 72. The communications interface 28 in the remote unit 12 contains a communications interface circuit that can be included in a communications interface RFIC chip 74. Alternatively, the antenna interface 32, the UC 36, the DC 38, the synthesizer circuit 44, and the communications interface 28, or any combination or subset of the foregoing, could be included in a single remote unit RFIC chip 76.

The central unit 14 may be configured to support any frequencies desired, including but not limited to US FCC and Industry Canada frequencies (824-849 MHz on uplink and 869-894 MHz on downlink), US FCC and Industry Canada frequencies (1850-1915 MHz on uplink and 1930-1995 MHz on downlink), US FCC and Industry Canada frequencies (1710-1755 MHz on uplink and 2110-2155 MHz on downlink), US FCC frequencies (698-716 MHz and 776-787 MHz on uplink and 728-746 MHz on downlink), EU R & TTE frequencies (880-915 MHz on uplink and 925-960 MHz on downlink), EU R & TTE frequencies (1710-1785 MHz on uplink and 1805-1880 MHz on downlink), EU R & TTE frequencies (1920-1980 MHz on uplink and 2110-2170 MHz on downlink), US FCC frequencies (806-824 MHz on uplink and 851-869 MHz on downlink), US FCC frequencies (896-901 MHz on uplink and 929-941 MHz on downlink), US FCC frequencies (793-805 MHz on uplink and 763-775 MHz on downlink), and US FCC frequencies (2495-2690 MHz on uplink and downlink), medical telemetry frequencies, and WLAN frequencies. Further, the central unit 14 may be configured to support frequency division duplexing (FDD) and time divisional duplexing (TDD).

In another embodiment, an exemplary remote unit 12 may be configured to support up to four (4) different radio bands/carriers (e.g. ATT, VZW, TMobile, Metro PCS: 700LTE/850/1900/2100). Radio band upgrades can be supported by adding remote expansion units over the same communications media (or upgrade to MIMO on any single band). The remote units 12 and/or remote expansion units may be configured to provide external filter interface to mitigate potential strong interference at 700 MHz band (Public Safety, CH51,56); Single Antenna Port (N-type) provides DL output power per band (Low bands (<1 GHz): 14 dBm, High bands (>1 GHz): 15 dBm); and satisfies the UL System RF spec (UL Noise Figure: 12 dB, UL IIP3: −5 dBm, UL AGC: 25 dB range).

With continuing reference to FIG. 1, the components of the distributed antenna system 10, including the communications media 26, can be deployed in close proximity to other cabling 72 that carries electrical signals. Electromagnetic noise 74 emitted by the cabling 72 may be induced into the communications media 26 thereby adding noise to and interfering with the communications signals 24D, 24U carried over the communications media 26. The components of the distributed antenna system 10 and communications media 26 may also be deployed in close proximity to other radiating equipment 76 that radiates electrical signals. Electromagnetic noise 78 emitted by the radiating equipment 76 may also be induced into the communications media 26 thereby adding noise to and interfering with the communications signals 24D, 24U carried over the communications media 26. This induced noise can particularly cause communications performance issues if the distributed antenna system 10 is operating at or near bandwidth capacity of the communications media 26 (e.g., 100+ MHz for Ethernet signals communicated over CATS cable). This electromagnetic noise may be induced in the communications media 26 at different frequencies non-uniformly over the frequency spectrum of the distributed antenna system 10. The transmission power of the communications signals 24D, 24U could be increased to increase the signal-to-noise (S/N) ratio, but with increased power consumption with less efficiency.

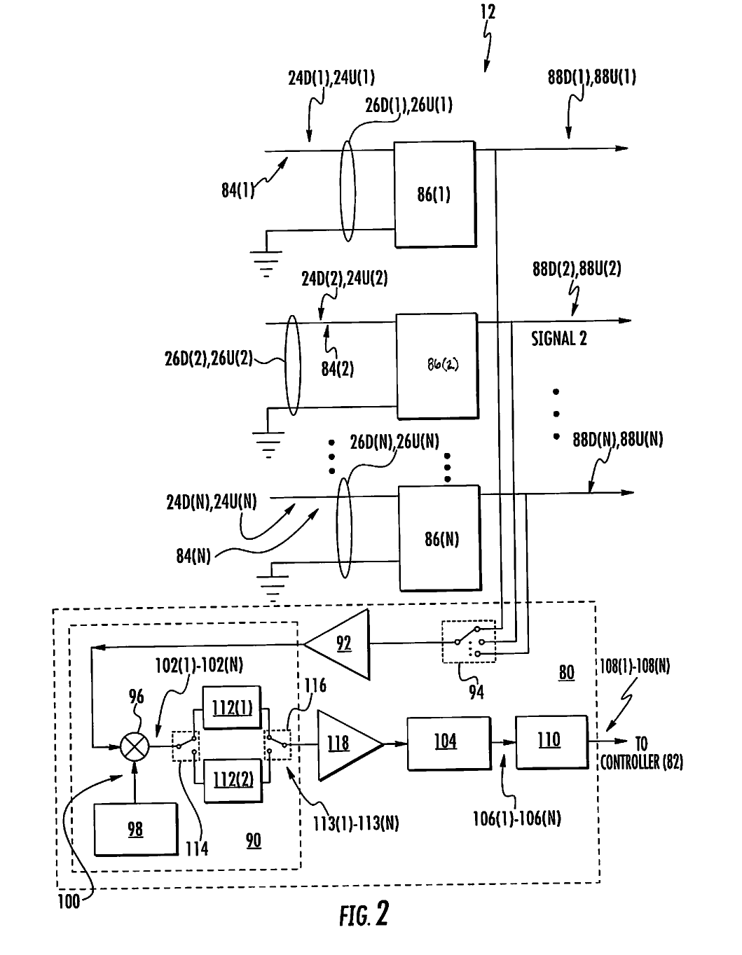

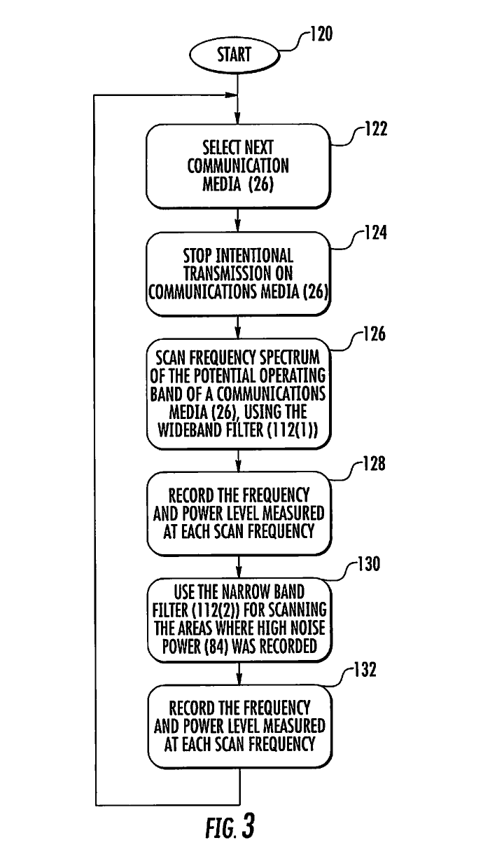

In this regard, this embodiment of the distributed antenna system 10 includes one or more noise detection circuits 80. A noise detection circuit 80 is provided in each of the remote units 12 in this embodiment. The noise detection circuit 80 is configured to detect noise in the distributed antenna system 10, and particularly noise that may be inducted on the communications media 26, such as from cable 72 and radiating equipment 76. In this embodiment, the noise detection circuit 80 can be controlled by the central unit 14, and particularly by a controller 82 provided in the central unit 14. As will be discussed in more detail below with regard to FIGS. 2 and 3, the noise detection circuit 80 is instructed by the controller 82 to scan communications signals carried over the communications medium 26. The noise detection circuit 80 is configured to scan any signals (i.e., noise) induced on the communications medium 26 at a plurality of scan frequencies in the frequency spectrum of the distributed antenna system 10. The noise detection circuit 80 is configured to generate output scan communications signals centered at each scan frequency. A power detector in the noise detection circuit 80 can detect the energy level in the output scan communications signals indicative of noise levels at the scan frequency. The noise levels at the scan frequencies can be collected and recorded by the controller 82 to determine optimal frequencies for communicating the communications signals 24D, 24U to reduce or eliminate the noise mixed with the communications signals 24D, 24U and thereby improve communications performance.

In this regard, FIG. 2 is a schematic diagram of the exemplary noise detection circuit 80 in FIG. 1. The noise detection circuit 80 is configured to receive signals (e.g., noise) communicated over the communications media 26. In this embodiment, the noise detection circuit 80 is illustrated as being able to receive signals communicated over the downlink communications media 26D or the uplink communications media 26U. These signals may be noise signals 84(1)-84(N) induced on the downlink or uplink communications media 26D(1)-26D(N), 26U(1)-26U(N), downlink or uplink communications signals 24D(1)-24D(N), 24U(1)-24U(N), or a combination of both. As will be discussed in more detail below, the noise detection circuit 80 may be controlled to detect noise when downlink or uplink communications signals 24D(1)-24D(N), 24U(1)-24U(N) are not being communicated over the downlink communications media 26D(1)-26D(N) or uplink communications media 26U(1)-26U(N), respectively. As illustrated in FIG. 2, the noise detection circuit 80 is configured to receive signals communicated over a plurality of communications media 26D(1)-26D(N) or 26U(1)-26U(N), where ‘N’ is an number of communications links between the central unit 14 and a remote unit 12. This is because a remote unit 12 may be configured to be communicatively coupled to more than one downlink communications medium 26D or uplink communications medium 26U.

With continuing reference to FIG. 2, in this example, automatic gain controls (AGC) 86(1)-86(N) are provided to provide optional gain control for downlink communications signals 88D(1)-88D(N) or uplink communications signals 88U(1)-88U(N), which may include induced noise signals, communicated over the downlink communications media 26D(1)-26D(N) or uplink communications media 26U(1)-26U(N). The noise detection circuit 80 includes a scanning circuit 90 that is configured to receive downlink communications signals 88D(1)-88D(N) or uplink communications signals 88U(1)-88U(N) as input distributed antenna system communications signals. The downlink communications signals 88D(1)-88D(N) or uplink communications signals 88U(1)-88U(N) may optionally be amplified by an amplifier 92. To allow the scanning circuit 90 to scan one of the downlink communications signals 88D(1)-88D(N) or uplink communications signals 88U(1)-88U(N) at a time, a switch 94 is also provided in the noise detection circuit 80. The switch is controllable to be switched to selectively couple one of the downlink communications signals 88D(1)-88D(N) or uplink communications signals 88U(1)-88U(N) to the scanning circuit 90.

With continuing reference to FIG. 2, the scanning circuit 90 is configured to scan the selected the downlink communications signals 88D(1)-88D(N) or uplink communications signals 88U(1)-88U(N) at a plurality of scan frequencies in the frequency spectrum of the distributed antenna system 10. The level of noise induced on the downlink communications media 26D(1)-26D(N) or the uplink communications media 26U(1)-26U(N) may be frequency dependent and only located at certain frequency ranges. Thus, by scanning the downlink communications signals 88D(1)-88D(N) or uplink communications signals 88U(1)-88U(N) at a plurality of scan frequencies over the frequency spectrum of the distributed antenna system 10, the frequency location of any noise signals can be determined. In this regard, the scanning circuit 90 includes a mixer 96. A local oscillator 98 is provided that is configured to generate an input oscillator signal 100 at each scan frequency desired. In this regard, the local oscillator 98 is controllable to generate input oscillator signals 100 at different frequencies to be mixed by the mixer 96 with the downlink communications signals 88D(1)-88D(N) or uplink communications signals 88U(1)-88U(N) to scan the frequency spectrum for noise. The mixer 96 provides a plurality of output scan communications signals 102(1)-102(N) at the scan frequencies. The local oscillator 98 may also be controlled to provide the input oscillator signal 100 at a given frequency for a particular defined period of time, known as dwell time, to allow time for any induced noise at the scan frequency provided by the frequency of the input oscillator signal 100 to be detected.

With continuing reference to FIG. 2, the output scan communications signals 102(1)-102(N) are provided to a power detector 104. The power detector 104 is configured to detect the energy level of the plurality of output scan communications signals 102(1)-102(N) to detect noise levels as a function of scan frequency. The power detector 104 is also configured to provide a plurality of output signals 106(1)-106(N) indicative of the noise level of the noise signals 84(1)-84(N) induced in the distributed antenna system 10 and the downlink communications media 26D(1)-26D(N) and/or the uplink communications media 26U(1)-26U(N) for the scan frequencies. The plurality of output signals 106(1)-106(N) may be converted to digital output signals 108(1)-108(N) by an analog-to-digital converter (ADC) 110 that may be included in the noise detection circuit 80. As will be discussed in more detail below, the plurality of digital output signals 108(1)-108(N) may be communicated from the noise detection circuit 80 to the controller 82 in the central unit 14 for analysis and to determine the desired frequency for the downlink communications signals 24D and/or the uplink communications signals 24U to avoid or eliminate interference from induced noise.

With continuing reference to FIG. 2, the scanning circuit 90 may also include one or more operational filters 112(1), 112(2) to filter the output scan communications signals 102(1)-102(N) in a particular frequency band in filtered output signals 113(1)-113(N) to detect the bandwidth of any detected noise signals 84(1)-84(N). For example, wide band filter 112(1) may be a wide frequency band filter, for example having a frequency band of 100 MHz. The wide band filter 112(1) can be used to effectively determine if the noise signals 84(1)-84(N) are spread over the wide frequency band of the wide band filter 112(1) and thus constitute wide band noise. Narrow band noise can be detected by providing narrow band filter 112(2) as a narrow frequency band filter. For example, the narrow band filter 112(2) may have a frequency band of 10 MHz to detect narrow band noise in a 10 MHz band.

With continuing reference to FIG. 2, switches 114, 116 may be provided in the scanning circuit 90 to selectively switch either the wide band filter 112(2) or the narrow band filter 112(2) to receive and filter the output scan communications signals 102(1)-102(N). For example, it may be desired to apply the wide band filter 112(1) to the output scan communications signals 102(1)-102(N) to scan for wide band noise first. Then, in an area of the frequency spectrum where wide band noise is detected, the narrow band filter 112(2) can be applied to determine whether the discovered noise signals is narrow band noise or wide band noise. This technique may reduce scanning time to scan the frequency spectrum, as opposed to scanning only using the narrow band filter 112(1) taking X times longer (where X=ratio of frequency band of wide band filter 112(1) to frequency band of narrow band filter 112(2)). An optional amplifier 118, such as a logarithmic amplifier, may also be provided to amplify the filtered output signals 113(1)-113(N) before the filtered output signals 113(1)-113(N) are provided to the power detector 104.

FIG. 3 is a flowchart illustrating an exemplary process of controlling the noise detection circuit 80 and the operational filters 112(1), 112(2) in FIG. 2 to measure and record the level of the noise signals 84(1)-84(N). The process may be initiated by the controller 82 instructing a noise detection circuit 80 to begin scanning (block 120). The controller 82 instructs the switch 94 in the noise detection circuit 80 to switch to a particular, or the next communications media 26D, 26U to be scanned for the noise signals 84(1)-84(N) (block 122). The controller 82 may then cause the central unit 14 (e.g., the communications interface 18) to stop transmission of the downlink communications signals 20D to be communicated as the downlink communications signals 24D over the downlink communications medium 26D(1)-26D(N) to be able to detect energy on the downlink communications medium 26D(1)-26D(N) as noise signals 84(1)-84(N) (block 124). Likewise, if it is desired to detect noise levels on the uplink communications medium 26U(1)-26U(N), the remote unit 12 may halt any transmissions of uplink communications signals 24U over the uplink communications medium 26U(1)-26U(N) so that the noise detection circuit 80 can detect energy on the uplink communications medium 26U(1)-26U(N) as noise signals 84(1)-84(N).

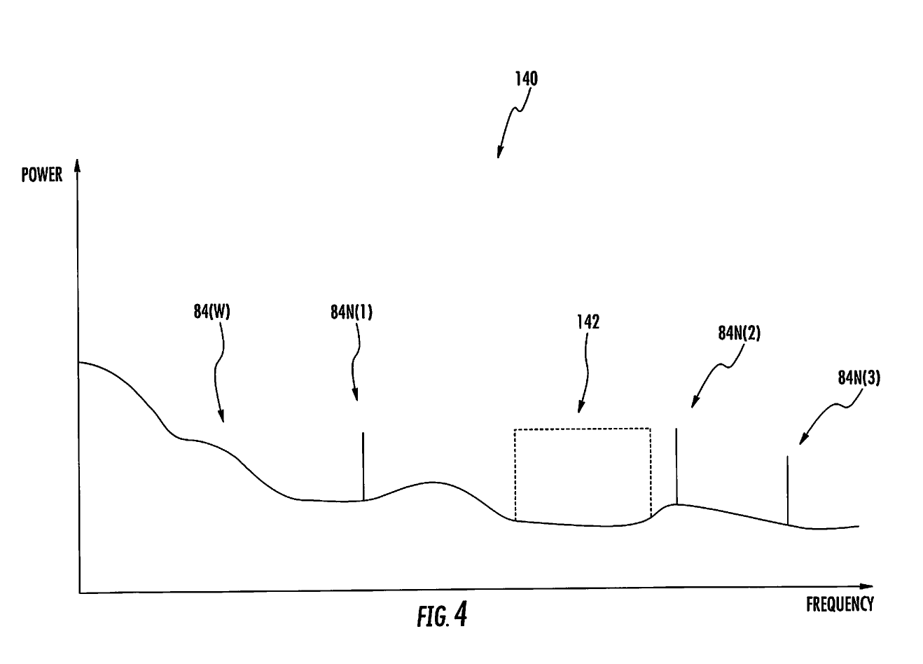

With continuing reference to FIG. 3, the controller 82 then instructs the scanning circuit 90 of the noise detection circuit 80 to scan for the noise signals 84(1)-84(N) using the wide band filter 112(1), as described above (block 126). The controller 82 can then record the frequency and power level measured for each scan frequency for noise analysis (block 128). The controller 82 can then instruct the scanning circuit 90 of the noise detection circuit 80 to scan for the noise signals 84(1)-84(N) using the narrow band filter 112(2), as described above (block 130). The controller 82 records the frequency and power level measured for each scan frequency for noise analysis (block 132). The process in FIG. 3 can be repeated for each of the downlink communications media 26D(1)-26D(N) and/or the uplink communications media 26U(1)-26U(N) (blocks 122-132). As an example, FIG. 4 is a spectrum map 140 created by the controller 82 that illustrates detected noise signals 84, including wide band noise 84(W) and narrow band noise 84N(1)-84N(3). As will be discussed in more detail below, the controller 82 can use the spectrum map 140 to detect frequency bands where noise levels are minimal or not present, such as frequency area 142 in FIG. 4.

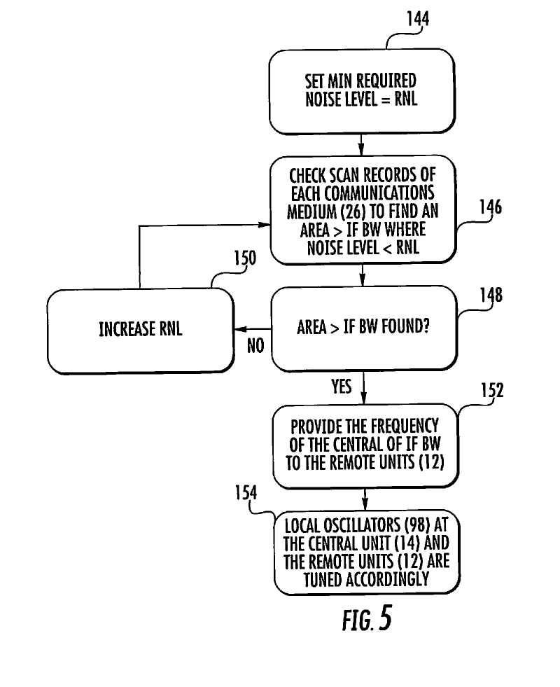

FIG. 5 is a flowchart illustrating an exemplary process of the controller 82 of the central unit 14 in the distributed antenna system 10 in FIG. 1 evaluating the noise levels detected by the noise detection circuit 80 in FIG. 3. In this regard, with reference to FIG. 5, the controller 82 is configured to evaluate or analyze the spectrum map 140 in FIG. 4 determined by the controller 82. There will be a separate spectrum map 140 for each communications medium 26 scanned. The controller 82 uses the noise levels in the spectrum map 140 to determine if the frequency of the communications signals 24D, 24U should be adjusted, via frequency shifting, to a frequency outside the detected noise levels. For example, it may be desirable to frequency shift the communications signals 20D, 20U to provide communications signals 24D, 24U at a center or carrier frequency that is outside detected noise levels so that induced noise does not impact or minimally impacts communications performance.

In this regard, with reference to FIG. 5, the controller 82 is configured to set a predefined threshold noise level, which may be a minimum required noise level (RNL), to be detected at each scan frequency in the spectrum map 140 (block 144). The RNL is the minimum noise level that the controller 82 will be to determine that noise exists at a given frequency band such that the frequency of the communications signals 24D, 24U should be set outside of such frequency band to improve communications performance. The controller 82 checks the spectrum map 140 for each communications medium 26 scanned to find an area in the spectrum map 140 greater than the bandwidth of the communications signals 24D, 24U and where the detected noise level is less than the RNL (block 146) (e.g., frequency area 142 in FIG. 4). If such an area in the spectrum map 140 is not found, the RNL is increased (block 150), and the spectrum map 140 reanalyzed (block 146). If such an area is found in the spectrum map 140 (block 148), the controller 82 instructs the synthesizer circuit 44 in the remote units 12 (FIG. 1) to frequency shift the uplink communications signals 30U to provide uplink communications signals 24U at the center frequency in the detected area of low noise in the spectrum map 140 outside of the frequency of the noise levels above the RNL (block 152). The controller 82 also controls the synthesizer circuit 42 (FIG. 1) to frequency shift the downlink communications signals 20D to provide the downlink communications signals 24D to the center frequency in the detected area of low noise in the spectrum map 140 outside of the frequency of the noise levels above the RNL (block 154). Each of the remote units 12 can be tuned in this manner.

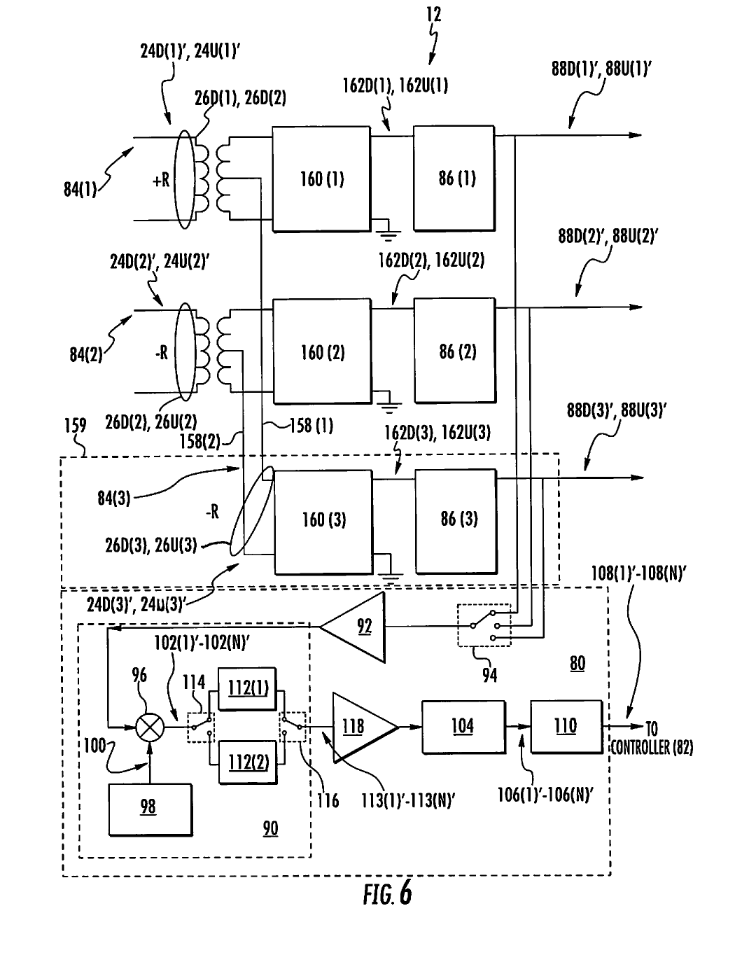

The noise detection circuit 80 and the processes of detecting noise levels in the communications media 26D, 26U and adjusting the frequency of communications signals 24D, 24U outside the frequency(ies) of the detected noise levels can be provided for other communications media schemes. In this regard, FIG. 6 is a schematic diagram of the noise detection circuit 80 that can be deployed in the remote unit 12 of the distributed antenna system 10 in FIG. 1 where the communications medium 26D, 26U is configured in a phantom circuit arrangement. In this regard, downlink communications signals 24D(1), 24D(2) are communicated over the downlink communications media 26D(1), 26D(2). Uplink communications signals 26U(1)', 26U(2)′ are communicated over the uplink communications media 26U(1), 26U(2).

With continuing reference to FIG. 6, a phantom circuit 159 is provided that is derived from the downlink communications media 26D(1), 26D(2) or the uplink communications media 26U(1), 26U(2). Each of the downlink communications media 26D(1), 26D(2) or the uplink communications media 26U(1), 26U(2) act as a communications media 26D(3), 26U(3) to provide a third communication link. The downlink communications signals 26D(1)'-26D(3)′ or the uplink communications signals 26U(1)'-26U(3)′ can be provided to balance-to-unbalancing circuits 160(1)-160(3) to provide downlink communications signals 162D (1)-162D(3) or the uplink communications signals 162U(1)-162U(3). The downlink communications signals 162D (1)-162D (3) or the uplink communications signals 162U(1)-162U(3) are provided to AGC circuits 86(1)-86(3), respectively to provide downlink communication signals 88D(1)′-88D(3)′ or uplink communications signals 88U(1)′-88U(3)′. The downlink communication signals 88D(1)′-88D(3)′ or uplink communications signals 88U(1)′-88U(3)′ can be provided in the noise detection circuit 80 to scan for noise levels as previously described with regard to FIG. 2

It may be desirable to detect noise levels and adjust frequencies of communications signals in distributed antenna systems that are configured to distribute both digital data services and RF communications services. Examples of digital data services include, but are not limited to, Ethernet, WLAN, WiMax, WiFi, Digital Subscriber Line (DSL), and LTE, etc. Ethernet standards could be supported, including but not limited to 100 Megabits per second (Mbs) (i.e., fast Ethernet) or Gigabit (Gb) Ethernet, or ten Gigabit (10G) Ethernet. Examples of digital data devices include, but are not limited to, wired and wireless servers, wireless access points (WAPs), gateways, desktop computers, hubs, switches, remote radio heads (RRHs), baseband units (BBUs), and femtocells. A separate digital data services network can be provided to provide digital data services to digital data devices.

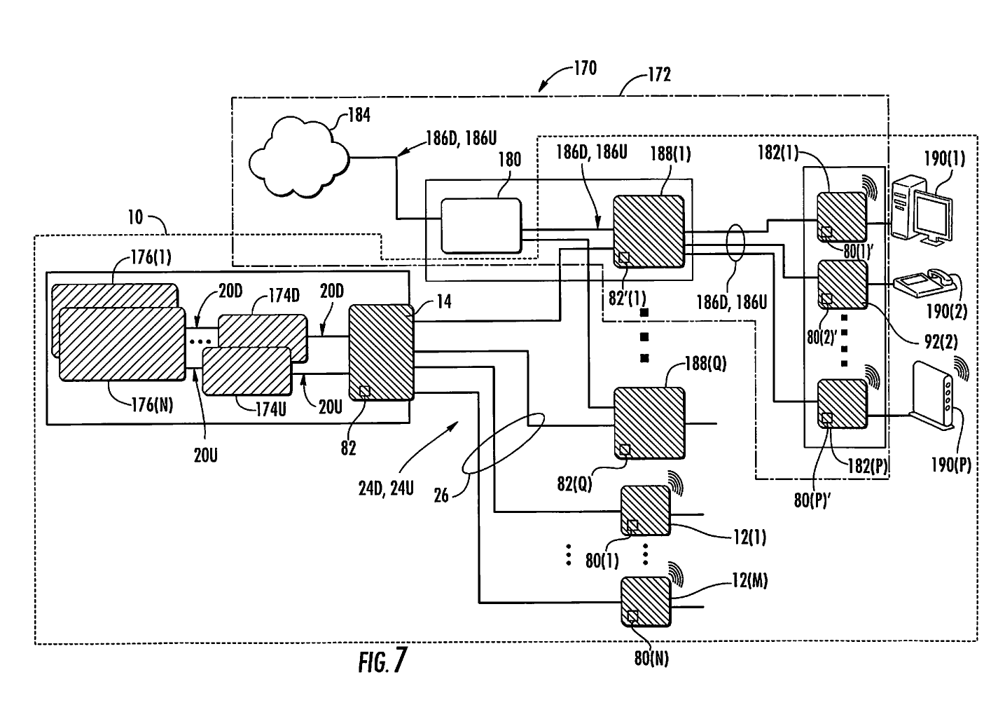

In this regard, FIG. 7 is a schematic diagram of an exemplary distributed antenna system 170 that includes the distributed antenna system 10 in FIG. 1 and a wireless local access network (WLAN) system 172 for providing digital data services. In this regard, the distributed antenna system 10 includes the central unit 14 previously described above with regard to FIG. 1. The central unit 14 is configured to receive the downlink electrical communications signals 20D through downlink interfaces 174D from one or more base stations 176(1)-176(N), wherein N can be any number. The central unit 14 can be configured to receive RF communications services from multiple base stations 176(1)-176(N) to support multiple RF radio bands in the distributed communication system 10. The central unit 14 is also configured to provide the downlink RF communication signals 24D to the remote units 12(1)-12(N) and receive the uplink RF communications signals 24U from remote units 12(1)-12(N) over the communications media 26. M number of remote units 12 signifies that any number, M number, of remote units 12 could be communicatively coupled to the central unit 14, as desired.

With continuing reference to FIG. 7, a digital data switch 180 may also be provided in the WLAN system 172. The digital data switch 180 may be provided in the WLAN system 172 for providing digital data signals, such as for WLAN services for example, to remote units 182(1)-182(P) configured to support digital data services, wherein P signifies that any number of the remote units 182 may be provided and supported by the WLAN system 172. The digital data switch 180 may be coupled to a network 184, such as the Internet. Downlink digital data signals 186D from the network 184 can be provided to the digital data switch 180. The downlink digital data signals 186D can be then provided to the remote units 182(1)-182(P) through slave central units 188(1)-188(Q), wherein Q can be any number desired. Controllers 82(1)′-82(Q)′ like controller 82 provided in central unit 14 may be included in the slave central units 188(1)-188(Q) to control scanning of noise levels and adjust frequency of digital data signals 186D, 186U. The digital data switch 180 can also receive uplink digital data signals 186U from the remote units 182(1)-182(P) to be provided back to the network 184. The slave central units 188(1)-188(Q) also receive the downlink RF communications signals 24D and provide uplink RF communications signals 24U from the remote units 182(1)-182(P) to the central unit 14 in this embodiment. In this regard, the remote units 182(1)-182(P), by being communicatively coupled to a slave central unit 188(1) that supports both the RF communications services and the digital data services, is included in both the distributed antenna system 10 and the WLAN system 172 to support RF communication services and digital data services, respectively, with client devices 100(1)-100(P). For example, such remote unit 182 may be configured to communicate wirelessly with the WLAN user equipment (e.g., a laptop) and Wide Area Wireless service user equipment (e.g., a cellular phone).

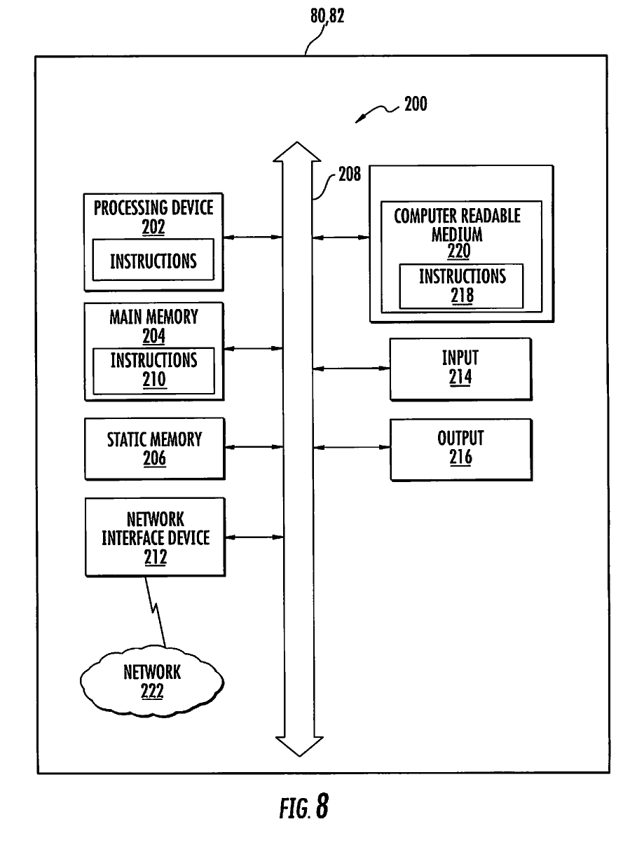

The noise detection circuits 80 and/or the controllers 82 disclosed herein can include a computer system. In this regard, FIG. 8 is a schematic diagram representation of additional detail regarding an exemplary form of an exemplary computer system 200 that is adapted to execute instructions from an exemplary computer-readable medium to perform noise level detection and/or noise level analysis and frequency adjustment. In this regard, the computer system 200 includes a set of instructions for causing the distributed antenna system component(s) to provide its designed functionality. The distributed antenna system component(s) may be connected (e.g., networked) to other machines in a LAN, an intranet, an extranet, or the Internet. The distributed antenna system component(s) may operate in a client-server network environment, or as a peer machine in a peer-to-peer (or distributed) network environment. While only a single device is illustrated, the term “device” shall also be taken to include any collection of devices that individually or jointly execute a set (or multiple sets) of instructions to perform any one or more of the methodologies discussed herein. The distributed antenna system component(s) may be a circuit or circuits included in an electronic board card, such as a printed circuit board (PCB) as an example, a server, a personal computer, a desktop computer, a laptop computer, a personal digital assistant (PDA), a computing pad, a mobile device, or any other device, and may represent, for example, a server or a user's computer. The exemplary computer system 200 in this embodiment includes a processing device or processor 202, a main memory 204 (e.g., read-only memory (ROM), flash memory, dynamic random access memory (DRAM) such as synchronous DRAM (SDRAM), etc.), and a static memory 206 (e.g., flash memory, static random access memory (SRAM), etc.), which may communicate with each other via the data bus 208. Alternatively, the processing device 202 may be connected to the main memory 204 and/or static memory 206 directly or via some other connectivity means. The processing device 202 may be a controller, and the main memory 204 or static memory 206 may be any type of memory.

The processing device 202 represents one or more general-purpose processing devices such as a microprocessor, central processing unit, or the like. More particularly, the processing device 202 may be a complex instruction set computing (CISC) microprocessor, a reduced instruction set computing (RISC) microprocessor, a very long instruction word (VLIW) microprocessor, a processor implementing other instruction sets, or processors implementing a combination of instruction sets. The processing device 202 is configured to execute processing logic in instructions 210 for performing the operations and steps discussed herein.

The computer system 200 may further include a network interface device 212. The computer system 200 also may or may not include an input 214 to receive input and selections to be communicated to the computer system 200 when executing instructions. The computer system 200 also may or may not include an output 216, including but not limited to a display, a video display unit (e.g., a liquid crystal display (LCD) or a cathode ray tube (CRT)), an alphanumeric input device (e.g., a keyboard), and/or a cursor control device (e.g., a mouse).

The computer system 200 may or may not include a data storage device that includes instructions 218 stored in a computer-readable medium 220. The instructions 218 may also reside, completely or at least partially, within the main memory 206 and/or within the processing device 202 during execution thereof by the computer system 200, the main memory 204 and the processing device 202 also constituting computer-readable medium. The instructions 218 may further be transmitted or received over a network 222 via the network interface device 212.

While the computer-readable medium 220 is shown in an exemplary embodiment to be a single medium, the term “computer-readable medium” should be taken to include a single medium or multiple media (e.g., a centralized or distributed database, and/or associated caches and servers) that store the one or more sets of instructions. The term “computer-readable medium” shall also be taken to include any medium that is capable of storing, encoding or carrying a set of instructions for execution by the processing device and that cause the processing device to perform any one or more of the methodologies of the embodiments disclosed herein. The term “computer-readable medium” shall accordingly be taken to include, but not be limited to, solid-state memories, optical and magnetic medium, and carrier wave signals.

The embodiments disclosed herein include various steps. The steps of the embodiments disclosed herein may be performed by hardware components or may be embodied in machine-executable instructions, which may be used to cause a general-purpose or special-purpose processor programmed with the instructions to perform the steps. Alternatively, the steps may be performed by a combination of hardware and software.

The embodiments disclosed herein may be provided as a computer program product, or software, that may include a machine-readable medium (or computer-readable medium) having stored thereon instructions, which may be used to program a computer system (or other electronic devices) to perform a process according to the embodiments disclosed herein. A machine-readable medium includes any mechanism for storing or transmitting information in a form readable by a machine (e.g., a computer). For example, a machine-readable medium includes a machine-readable storage medium (e.g., read only memory (“ROM”), random access memory (“RAM”), magnetic disk storage medium, optical storage medium, flash memory devices, etc.).

The various illustrative logical blocks, modules, and circuits described in connection with the embodiments disclosed herein may be implemented or performed with a processor, a Digital Signal Processor (DSP), an Application Specific Integrated Circuit (ASIC), a Field Programmable Gate Array (FPGA) or other programmable logic device, discrete gate or transistor logic, discrete hardware components, or any combination thereof designed to perform the functions described herein. A controller may be a processor. A processor may be a microprocessor, but in the alternative, the processor may be any conventional processor, controller, microcontroller, or state machine. A processor may also be implemented as a combination of computing devices, e.g., a combination of a DSP and a microprocessor, a plurality of microprocessors, one or more microprocessors in conjunction with a DSP core, or any other such configuration.

The embodiments disclosed herein may be embodied in hardware and in instructions that are stored in hardware, and may reside, for example, in Random Access Memory (RAM), flash memory, Read Only Memory (ROM), Electrically Programmable ROM (EPROM), Electrically Erasable Programmable ROM (EEPROM), registers, a hard disk, a removable disk, a CD-ROM, or any other form of computer-readable medium known in the art. An exemplary storage medium is coupled to the processor such that the processor can read information from, and write information to, the storage medium. In the alternative, the storage medium may be integral to the processor. The processor and the storage medium may reside in an ASIC. The ASIC may reside in a remote station. In the alternative, the processor and the storage medium may reside as discrete components in a remote station, base station, or server.

Further, as used herein, it is intended that terms “fiber optic cables” and/or “optical fibers” include all types of single mode and multi-mode light waveguides, including one or more optical fibers that may be upcoated, colored, buffered, ribbonized and/or have other organizing or protective structure in a cable such as one or more tubes, strength members, jackets or the like. The optical fibers disclosed herein can be single mode or multi-mode optical fibers. Likewise, other types of suitable optical fibers include bend-insensitive optical fibers, or any other expedient of a medium for transmitting light signals. An example of a bend-insensitive, or bend resistant, optical fiber is ClearCurve® Multimode fiber commercially available from Corning Incorporated. Suitable fibers of this type are disclosed, for example, in U.S. Patent Application Publication Nos. 2008/0166094 and 2009/0169163, the disclosures of which are incorporated herein by reference in their entireties.

Many modifications and other embodiments of the embodiments set forth herein will come to mind to one skilled in the art to which the embodiments pertain having the benefit of the teachings presented in the foregoing descriptions and the associated drawings.

Therefore, it is to be understood that the description and claims are not to be limited to the specific embodiments disclosed and that modifications and other embodiments are intended to be included within the scope of the appended claims. It is intended that the embodiments cover the modifications and variations of the embodiments provided they come within the scope of the appended claims and their equivalents. Although specific terms are employed herein, they are used in a generic and descriptive sense only and not for purposes of limitation.

We claim:

1. A noise detection circuit for detecting noise in a distributed antenna system, comprising:
a scanning circuit configured to:
receive an input distributed antenna system communications signal;
scan the input distributed antenna system communications signal at a plurality of scan frequencies in a frequency spectrum of a distributed antenna system; and
generate a plurality of output scan communications signals each centered at a scan frequency among the plurality of scan frequencies; and
a power detector configured to detect an energy level of the plurality of output scan communications signals and provide a plurality of output signals indicative of noise levels in the distributed antenna system for each of the plurality of scan frequencies.

2. The noise detection circuit of claim 1, wherein the scanning circuit comprises:
a mixer; and
a local oscillator configured to generate a plurality of input oscillator signals each at a scan frequency among the plurality of scan frequencies;
the mixer configured to, for each of the plurality of scan frequencies:
receive the input distributed antenna system communication signal and an input oscillator signal at a scan frequency among the plurality of scan frequencies; and
mix the input distributed antenna system communications signal with the input oscillator signal at the scan frequency to provide an output scan communications signal among the plurality of output scan communications signals at the scan frequency.

3. The noise detection circuit of claim 1, further comprising at least one filter configured to receive the plurality of output scan communications signals and filter each of the plurality of output scan communications signals in a frequency band.

4. The noise detection circuit of claim 3, wherein the at least one filter is comprised of at least one wide band filter configured to filter the plurality of output scan communications signals in a wide band frequency, wherein the wide band frequency is approximately 100 MHz.

5. The noise detection circuit of claim 3, wherein the at least one filter is comprised of at least one narrow band filter configured to filter the plurality of output scan communications signals in a narrow band frequency.

6. The noise detection circuit of claim 3, wherein the at least one filter is comprised of a wide band filter configured to filter each of the plurality of output scan communications signals in a wide frequency band, and a narrow band filter configured to filter each of the plurality of output scan communications signals in a narrow frequency band.

7. The noise detection circuit of claim 1, further comprising an analog-to-digital converter (ADC) configured to convert the plurality of output signals to a plurality of digital output signals.

8. The noise detection circuit of claim 1, further comprising a logarithmic amplifier configured to amplify the plurality of output scan communications signals.

9. The noise detection circuit of claim 1, wherein the scanning circuit is configured to receive a plurality of input distributed antenna system communications signals and scan the plurality of input distributed antenna system communications signals each at the plurality of scan frequencies in the frequency spectrum of the distributed antenna system.

10. The noise detection circuit of claim 9, further comprising an input switch configured to switchably couple each of the plurality of input distributed antenna system communications signals to the scanning circuit.

11. The noise detection circuit of claim 1, wherein the scanning circuit is further configured to scan the input distributed antenna system communications signal for a defined dwell time.

12. A central unit providing communications signals in a distributed antenna system, comprising:
at least one communications interface configured to:
receive communications signals at a communications frequency for at least one communications service; and
communicate the communications signals over at least one communications medium at a tuned frequency between a plurality of remote units; and
a controller configured to:
select a communications medium among the at least one communications medium for a remote unit among the plurality of remote units;
instruct a noise detection circuit to scan the selected communications medium at a plurality of scan frequencies in a frequency spectrum;
receive a power level on the selected communications medium at each of the plurality of scan frequencies; and
store a scan frequency and power level on the selected communications medium for each of the plurality of scan frequencies.

13. The central unit of claim 12, wherein the at least one communications interface is configured to receive downlink communication signals for the at least one communications service and communicate the downlink communications signals over at least one downlink communications medium to the plurality of remote units; and
the controller is configured to:
select a downlink communications medium among the at least one downlink communications medium for the remote unit among the plurality of remote units;
instruct the noise detection circuit to scan the selected downlink communications medium at the plurality of scan frequencies in the frequency spectrum;
receive a power level on the selected downlink communications medium at each of the plurality of scan frequencies; and
store the scan frequency and the power level on the selected downlink communications medium at each of the plurality of scan frequencies.

14. The central unit of claim 12, wherein the at least one communications interface is configured to receive uplink communication signals for the at least one communications service over at least one uplink communications media from the plurality of remote units; and
the controller is configured to:
select an uplink communications medium among the at least one uplink communications media for the remote unit among the plurality of remote units;
instruct the noise detection circuit to scan the selected uplink communications medium at the plurality of scan frequencies in the frequency spectrum;
receive a power level on the selected uplink communications medium at each of the plurality of scan frequencies; and
store the scan frequency and the power level on the selected uplink communications medium at each of the plurality of scan frequencies.

15. The central unit of claim 12, wherein the controller is further configured to generate a frequency spectrum map comprised of the scan frequency and power level on the at least one communications medium at each of the plurality of scan frequencies.

16. The central unit of claim 12, wherein the controller is further configured to halt transmission of the communications signals on the selected communications medium before instructing the noise detection circuit to scan the selected communications medium.

17. The central unit of claim 12, wherein the controller is configured to instruct the noise detection circuit to scan the selected communications medium in a defined frequency band.

18. The central unit of claim 12, wherein the controller is configured to instruct the noise detection circuit to scan the selected communications medium in a defined wide frequency band.

19. The central unit of claim 18, wherein the controller is further configured to instruct the noise detection circuit to scan the selected communications medium in a defined narrow frequency band for a defined wide frequency band.

20. The central unit of claim 12, wherein the controller is configured to instruct the noise detection circuit to scan the selected communications medium in a defined narrow frequency band.

21. The central unit of claim 12, wherein the at least one communications medium is comprised of a plurality of communications media;
wherein the controller is further configured, for each of the plurality of communications media, to:
select the communications medium among the plurality of communications media for a remote unit among the plurality of remote units;
instruct the noise detection circuit to scan the selected communications medium at a plurality of scan frequencies in a frequency spectrum;
receive the power level on the selected communications medium at each of the plurality of scan frequencies; and
store the scan frequency and power level on the selected communications medium for each of the plurality of scan frequencies.

22. The central unit of claim 12, wherein the controller is configured to instruct the noise detection circuit to scan the selected communications medium at a plurality of scan frequencies in a frequency spectrum for a defined dwell time.

23. The central unit of claim 12, wherein the controller is further configured to:
review noise level at each stored scan frequency; and
determine if the noise level at each stored scan frequency is above a predefined threshold noise level.

24. The central unit of claim 23, wherein the controller is further configured to control the tuned frequency of the communications signals to be outside the scan frequency having a noise level about the predefined threshold noise level.

25. The central unit of claim 23, wherein the controller is further configured to increase the predefined threshold noise level if the noise level at each scan frequency is not above the predefined threshold noise level.

26. A distributed antenna system, comprising:
a plurality of remote units;
a plurality of noise detection circuits for detecting noise disposed in each of the plurality of remote units, each of the plurality of noise detection circuits comprising:
a scanning circuit configured to:
receive an input distributed antenna system communications signal;
scan the input distributed antenna system communications signal at a plurality of scan frequencies in a frequency spectrum of a distributed antenna system; and
provide a plurality of output scan communications signals each centered at a scan frequency among the plurality of scan frequencies; and
a power detector configured to detect an energy level of the plurality of output scan communications signals and provide a plurality of output signals indicative of noise levels in the distributed antenna system for each of the plurality of scan frequencies;
a central unit, comprising:
at least one communications interface configured to:
receive communications signals at a communications frequency for at least one communications service; and
communicate the communications signals over at least one communications medium at a tuned frequency between the plurality of remote units; and
a controller configured to:
select a communications medium among the at least one communications medium for a remote unit among the plurality of remote units;
instruct the plurality of noise detection circuits to each scan the selected communications medium at a plurality of scan frequencies in a frequency spectrum;
receive a power level on the selected communications medium at each of the plurality of scan frequencies from each of the plurality of noise detection circuits; and
store the scan frequency and power level on the selected communications medium for each of the plurality of scan frequencies for each of the plurality of noise detection circuits.

27. The distributed antenna system of claim 26, wherein each scanning circuit comprises:
a mixer; and
a local oscillator configured to generate a plurality of input oscillator signals each at a scan frequency among the plurality of scan frequencies;
the mixer configured to, for each of the plurality of scan frequencies:
receive the input distributed antenna system communication signal and an input oscillator signal at a scan frequency among the plurality of scan frequencies; and
mix the input distributed antenna system communications signal with the input oscillator signal at the scan frequency to provide an output scan communications signal among the plurality of output scan communications signals at the scan frequency.

28. The distributed antenna system of claim 26, wherein each of the plurality of noise detection circuits further comprise at least one filter configured to receive the plurality of output scan communications signals and filter each of the plurality of output scan communications signals in a frequency band.

29. The distributed antenna system of claim 26, wherein the at least one filter is comprised of a wide band filter configured to filter each of the plurality of output scan communications signals in a wide frequency band, and a narrow band filter configured to filter each of the plurality of output scan communications signals in a narrow frequency band.

30. The distributed antenna system of claim 26, wherein the controller is further configured to:
review noise level at each stored scan frequency for each of the plurality of noise detection circuits; and
determine if the noise level at each stored scan frequency for each of the plurality of noise detection circuits is above a predefined threshold noise level.

31. The distributed antenna system of claim 30, wherein the controller is further configured to control the tuned frequency of the communications signals to be outside the scan frequency having a noise level above the predefined threshold noise level, and to communicate the tuned frequency to at least one of the plurality of remote units.

32. The distributed antenna system of claim 30, wherein the controller is further configured to increase the predefined threshold noise level if the noise level at each scan frequency is not above the predefined threshold noise level.
